(19) United States
(12) Patent Application Publication
(10) Pub. No.: US 2022/0007746 A1
(43) Pub. Date: Jan. 13, 2022

(54) MATERIAL SYSTEM WITH PLURALITY OF PANELS, PROCESSES OF MANUFACTURE, AND METHODS OF USE

(71) Applicants: Jeff Williams, Hoisington, KS (US); Marcia Williams, Hoisington, KS (US)

(72) Inventors: Jeff Williams, Hoisington, KS (US); Marcia Williams, Hoisington, KS (US)

(21) Appl. No.: 16/927,250

(22) Filed: Jul. 13, 2020

(51) Int. Cl. A41B 13/10; A41D 31/30; A41D 31/12; H04Q 9/00

(52) U.S. Cl. CPC A41B 13/103; A41D 31/305; H04Q 2209/40; H04Q 9/00; H04Q 2209/10; A41D 31/125

(57) ABSTRACT

A material system with a plurality of panels, process of making, and methods of use are presented herein. The material system provides a plurality of panels that can be reconfigured in various ways so that a clean surface is made available to a user with minimal effort. Generally speaking, a burp cloth with a plurality of panels and an attachment feature is presented such that when a liquid is dispelled during a burping session, the contaminated panel used can be easily removed such that a clean panel is readily available.

### FIELD OF THE DISCLOSURE

This disclosure relates to an absorbent material system. More specifically and without limitation, this disclosure relates to an absorbent cloth system with a plurality of panels, processes of making, and methods of use. More specifically, and without limitation, this disclosure relates to a burp cloth system with a plurality of panels and methods of use. More specifically, and without limitation, the present disclosure relates to a burp cloth with a plurality of panels for use with infants and/or babies and a number of other methods of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Jeff Williams, Marcia Williams. All rights reserved.

### BACKGROUND OF THE DISCLOSURE

Burp cloths are old and well known in the art. During breast feeding and/or feeding, an infant or baby is likely to accumulate gas or air in the stomach during feeding; whether the feeding is breasting feeding, bottle feeding, or other types of feeding. This gas and/or air will likely cause discomfort for the baby until the baby is assisted. A baby is assisted through this discomfort in a process known as burping.

Burping is old and well known in the art. Burping involves placing an infant or baby in a position conducive to expelling the gas and/or air that has accumulated in the infant's stomach during feeding. Then, once the baby is placed into position, a light patting on the infant's back, usually the lower part of the back, will help the infant to burp and/or dispel accumulated gas and/or air. One common example of such a position, is for an adult and/or caretaker to place the infant against one's chest favoring one shoulder or the other. The infant's head is usually at rest on the caretaker's shoulder such that the mouth may be resting on the shoulder and/or within close proximity of the shoulder of the caregiver. Holding the infant in an upright position, the caretaker can then proceed in patting the lower back gently so as to loosen gas and/or air from the infant's stomach.

While burping is often helpful in comforting an ailing infant and/or dispelling gas and/or air to comfort an infant, commonly after feeding, burping also commonly results in vomiting or the dispelling of some or all of the fluids an infant has eaten. Rather than catch dispelled fluids and/or vomit, a caretaker often employs a burp cloth.

Burp cloths are common and well known in the art. Burp cloths are also known as burp pads, or simply cloths, or simply pads. Before, during, and/or after feeding a caretaker may drape a burp cloth over their shoulder so as to protect clothing from dispelled fluids during the burping process, during feeding, and even during sleeping to catch drool and other fluids dispelled from an infant. Burp cloths are generally soft and rectangular in shape. Burp cloths are often very similar to standard cloths which are used in absorbing materials, commonly for absorbing liquid materials.

Cloths are well known in the art. Cloths, or towels, are pieces of fabric and/or paper and/or other materials that are used to absorb moisture. Oftentimes a towel or cloth is used to wipe the body or other surfaces for the purpose of absorbing moisture and/or for cleaning the surface. Additionally, towels may serve as a drying material for drying a wet surface or for transferring moisture to a surface for cleaning and the like. Paper towels and towels made of a fabric or textile are commercially available and widespread and are a common household item found for cleaning or absorbing.

Absorption is the process of collecting molecules or atoms of a substance by bulking these molecules or atoms into the surface area spaces of a materials or second substance. The absorption process is how a towel or cloth is able to collect and hold an amount of liquid or other material. For the burping process, this absorption is key to the success of the process of keeping clothes clean and collecting unwanted substances for later disposal.

In the burping process and through common uses of using a burp towel or burp cloth, a baby dispels unwanted fluids onto the shoulder of a caretaker, where the shoulder of the caretaker is covered with a burp cloth. In this way, the fluids dispelled from an infant will land and come into direct contact with the burp cloth located on the shoulder of a human. Once the fluids are collected and the baby removed, then the burp cloth can be cleaned or otherwise disposed of. However, the process of feeding a baby is never quite this singular and is never quite this easy.

Infant feeding is the process of providing nutrition to an infant. Breast feeding is one common means of feeding an infant. Others, in some cases will rely on formulas, and still others may rely on a combination of both depending on the age of the infant. In this way, nutrition is delivered to a baby or infant. Furthermore, infants tend to eat many times a day. Newborn babies may feed, or eat, two to three times every hour. While the amount of food ingested is small, the feeding is frequent and may be around eight to twelve times during a twelve hour period.

During these frequent feedings, an infant may have multiple burpings to alleviate gas and/or air collection and allow space for more nutrition. Because of this, a baby may be burped multiple times during a feeding, or several times during the course of a single hour. For this reason, there may be many occurrences of vomiting or the dispelling of fluids. For this reason, multiple burp rags or burp towels are needed at frequent intervals. Additionally, each time that an infant is burped, they may collect debris on their face and need their face cleaned or wiped down.

For this reason, the amount of paper towels, burp towels, and the like is significant. Furthermore, cleaning a baby's face and keeping the baby's face out of already soiled burp towels becomes problematic during the course of a single feeding. For this reason, common burp towels are problematic and are difficult to use. Due to the quantity required, burp towels are inefficient. Due to the handling of a burp towel and the uses of a burp towel or other towel, burp towels present the art with long felt needs of improvement. Burp towels also present a problem of keeping a baby away from soiled areas of the towel.

Not only do burp towels have these problems, but regular towels, paper towels, cloths, and the like also have these issues. For wiping down a surface, once an area becomes soiled, more wiping only leads to the spreading of contaminants rather than the absorption of contaminants. Furthermore, once a towel has absorbed a contaminant or moisture, the towel is no longer dry and cannot be used to subsequently dry a surface.

Thus, there is a need in the art for an improved burp towel, and there is also a need in the art for an improved towel. There is a need in the art for a burp towel that prevents the issue of a baby wiping its face in the soiled areas of a burp towel during the feeding and burping process. There is a need in the art for a burp towel that can provide continued use during the feeding and burping and/or repeated feeding and burping process. There is a need in the art for an absorbent material that can clean and also dry a surface. There is a need in the art for an absorbent material that can clean one surface and subsequently clean another surface without transferring germs and/or other contaminants.

Presented herein, is a burp cloth with a plurality of panels that provides for multiple uses and/or multiple panels in a single cloth, said panels having a plurality of layers. In this way, a caretaker can flip or remove the first panel after the first panel has become soiled so as to move the first panel out of the way for a clean, ready to use, second panel and/or subsequent panel. In this way, having multiple panels attached to one another in an easy to handle manner provides the art with a burp cloth and/or absorbent material which increases ease, efficiency, functionality, cleanliness and the like for a user.

### SUMMARY OF THE DISCLOSURE

An absorbent material system with a plurality of panels, processes of manufacture, and methods of use is presented herein. The absorbent material system having a plurality of panels such that a first panel can be used and then retracted or moved and a second panel subsequently be used without discarding or adjusting. In the arrangement shown, as one example, a burp cloth with multiple panels is presented wherein the panels are attached in a way in which the first panel can be removed from position, depending on the means of attachment such that the second panel can be utilized.

An absorbent material system with a plurality of panels, processes of manufacture, and methods of use is presented herein. Accordingly, it is a principal object of the disclosure to provide a multi-paneled absorbent material which provides for ease of use and cleanliness for a user and/or an infant.

Furthermore, it is a principal object of the disclosure to provide an absorbent material system with a plurality of panels, processes of manufacture, and methods of use that improves upon the state of the art.

Another object of the disclosure is to provide an absorbent material system with a plurality of panels, processes of manufacture, and methods of use that is easy to use.

Yet another object of the disclosure is to provide an absorbent material system with a plurality of panels, processes of manufacture, and methods of use that provides multiple panels of absorbent material.

Another object of the disclosure is to provide an absorbent material system with a plurality of panels, processes of manufacture, and methods of use that provides an improved burp cloth.

Yet another object of the disclosure is to provide an absorbent material system with a plurality of panels, processes of manufacture, and methods of use that provides that state of the art with an improved cleaning cloth.

Another object of the disclosure is to provide an absorbent material system with a plurality of panels, processes of manufacture, and methods of use that may be disposable.

Yet another object of the disclosure is to provide an absorbent material system with a plurality of panels, processes of manufacture, and methods of use that have a plurality of panels which are conveniently attached to one another.

Another object of the disclosure is to provide an absorbent material system with a plurality of panels, processes of manufacture, and methods of use that prevents liquids from penetrating to clothing or skin.

Yet another object of the disclosure is to provide an absorbent material system with a plurality of panels, processes of manufacture, and methods of use that provides cleanliness.

Another object of the disclosure is to provide an absorbent material system with a plurality of panels, processes of manufacture, and methods of use that come in a variety of shapes.

Yet another object of the disclosure is to provide an absorbent material system with a plurality of panels, processes of manufacture, and methods of use that can be a variety of sizes.

Another object of the disclosure is to provide an absorbent material system with a plurality of panels, processes of manufacture, and methods of use that can provide a first panel that can be removed.

Yet another object of the disclosure is to provide an absorbent material system with a plurality of panels, processes of manufacture, and methods of use that can provide for having a first panel put back in place.

Another object of the disclosure is to provide an absorbent material system with a plurality of panels, processes of manufacture, and methods of use that collects messes dispelled during the baby feeding process.

Yet another object of the disclosure is to provide an absorbent material system with a plurality of panels, processes of manufacture, and methods of use that collects messes dispelled during the infant burping process.

Another object of the disclosure is to provide an absorbent material system with a plurality of panels, processes of manufacture, and methods of use that can be used to protect clothing.

Yet another object of the disclosure is to provide an absorbent material system with a plurality of panels, processes of manufacture, and methods of use that can clean a variety of surfaces such as faces of humans.

Another object of the disclosure is to provide an absorbent material system with a plurality of panels, processes of manufacture, and methods of use that provides for the cleaning of a variety of surfaces.

Yet another object of the disclosure is to provide an absorbent material system with a plurality of panels, processes of manufacture, and methods of use that can store contaminants without allowing contaminants in contact with a user.

Another object of the disclosure is to provide an absorbent material system with a plurality of panels, processes of manufacture, and methods of use that increases the surface area available for a user.

Yet another object of the disclosure is to provide an absorbent material system with a plurality of panels, processes of manufacture, and methods of use that provides a user with multiple panels or multiple cloth panels built into a single structure.

Another object of the disclosure is to provide an absorbent material system with a plurality of panels, processes of manufacture, and methods of use that are moisture resistant.

Yet another object of the disclosure is to provide an absorbent material system with a plurality of panels, processes of manufacture, and methods of use that are antibacterial.

Another object of the disclosure is to provide an absorbent material system with a plurality of panels, processes of manufacture, and methods of use that is antimicrobial.

Yet another object of the disclosure is to provide an absorbent material system with a plurality of panels, processes of manufacture, and methods of use that provides for reattaching multiple panels that have been previously removed.

Another object of the disclosure is to provide an absorbent material system with a plurality of panels, processes of manufacture, and methods of use that provides a caretaker the ability to burp a baby multiple times using a single burp cloth.

Yet another object of the disclosure is to provide an absorbent material system with a plurality of panels, processes of manufacture, and methods of use that prevents seepage of liquids dispelled onto the burp cloth.

Another object of the disclosure is to provide an absorbent material system with a plurality of panels, processes of manufacture, and methods of use that may provide at least one moisture barrier.

Yet another object of the disclosure is to provide an absorbent material system with a plurality of panels, processes of manufacture, and methods of use that may provide at least one absorbent layer of at least one panel.

Another object of the disclosure is to provide an absorbent material system with a plurality of panels, processes of manufacture, and methods of use that provides for a convenient attachment of a first panel to a second panel.

Yet another object of the disclosure is to provide an absorbent material system with a plurality of panels, processes of manufacture, and methods of use that provides a convenient attachment of a first panel to a second panel and a second panel to a third panel and a third panel to a fourth panel.

Another object of the disclosure is to provide an absorbent material system with a plurality of panels, processes of manufacture, and methods of use that is more convenient than carrying multiple burp cloths.

Yet another object of the disclosure is to provide an absorbent material system with a plurality of panels, processes of manufacture, and methods of use that provides enhanced ergonomics.

Another object of the disclosure is to provide an absorbent material system with a plurality of panels, processes of manufacture, and methods of use that is lightweight.

Yet another object of the disclosure is to provide an absorbent material system with a plurality of panels, processes of manufacture, and methods of use that is easy and fun to hold.

Another object of the disclosure is to provide an absorbent material system with a plurality of panels, processes of manufacture, and methods of use that is easy to grip.

Yet another object of the disclosure is to provide an absorbent material system with a plurality of panels, processes of manufacture, and methods of use that provides multiple grip locations.

Another object of the disclosure is to provide an absorbent material system with a plurality of panels, processes of manufacture, and methods of use that is durable.

Yet another object of the disclosure is to provide an absorbent material system with a plurality of panels, processes of manufacture, and methods of use that is disposable.

Another object of the disclosure is to provide an absorbent material system with a plurality of panels, processes of manufacture, and methods of use that have structural rigidity.

Yet another object of the disclosure is to provide an absorbent material system with a plurality of panels, processes of manufacture, and methods of use that accommodates varying sizes.

Another object of the disclosure is to provide an absorbent material system with a plurality of panels, processes of manufacture, and methods of use that is comfortable for a user.

Yet another object of the disclosure is to provide an absorbent material system with a plurality of panels, processes of manufacture, and methods of use that is comfortable for an infant.

Another object of the disclosure is to provide an absorbent material system with a plurality of panels, processes of manufacture, and methods of use that may have at least one hypo-allergenic layer.

Yet another object of the disclosure is to provide an absorbent material system with a plurality of panels, processes of manufacture, and methods of use that are soft.

Another object of the disclosure is to provide an absorbent material system with a plurality of panels, processes of manufacture, and methods of use that is absorbent.

Yet another object of the disclosure is to provide an absorbent material system with a plurality of panels, processes of manufacture, and methods of use that provides multiple methods of use.

Another object of the disclosure is to provide an absorbent material system with a plurality of panels, processes of manufacture, and methods of use that is easy to use.

Yet another object of the disclosure is to provide an absorbent material system with a plurality of panels, processes of manufacture, and methods of use that is safe to use.

Another object of the disclosure is to provide an absorbent material system with a plurality of panels, processes of manufacture, and methods of use that are fun to use.

Yet another object of the disclosure is to provide an absorbent material system with a plurality of panels, processes of manufacture, and methods of use that can be used repeatedly.

Another object of the disclosure is to provide an absorbent material system with a plurality of panels, processes of manufacture, and methods of use that is sustainable.

Yet another object of the disclosure is to provide an absorbent material system with a plurality of panels, processes of manufacture, and methods of use that is user friendly.

Another object of the disclosure is to provide an absorbent material system with a plurality of panels, processes of manufacture, and methods of use that is intuitive.

Yet another object of the disclosure is to provide an absorbent material system with a plurality of panels, processes of manufacture, and methods of use that provides for a pocket which allows access from a first panel to a second panel.

Another object of the disclosure is to provide an absorbent material system with a plurality of panels, processes of manufacture, and methods of use that can provide a cooling pouch.

Yet another object of the disclosure is to provide an absorbent material system with a plurality of panels, processes of manufacture, and methods of use that provides a warming pouch.

Another object of the disclosure is to provide an absorbent material system with a plurality of panels, processes of manufacture, and methods of use that provide a warmer environment.

Yet another object of the disclosure is to provide an absorbent material system with a plurality of panels, processes of manufacture, and methods of use that provides a pocket for an ice pack or similar.

Another object of the disclosure is to provide an absorbent material system with a plurality of panels, processes of manufacture, and methods of use that provides a holster.

Yet another object of the disclosure is to provide an absorbent material system with a plurality of panels, processes of manufacture, and methods of use that has a long useful life.

Another object of the disclosure is to provide an absorbent material system with a plurality of panels, processes of manufacture, and methods of use that has a plurality of panels, each of the plurality of panels having a plurality of layers.

These and other objects, features, or advantages of the present disclosure will become apparent from the specification and claims.

To meet the above objectives, an absorbent material system with a plurality of panels, processes of manufacture, and methods of use are presented having an aesthetic shape which improves upon ergonomics and visual appeal and has multiple panels conveniently affixed to one another. The absorbent material system with a plurality of panels, processes of manufacture, and methods of use presented herein provides a better user experience while also providing an increased product life while also providing for increased time of use for a single use while providing for multiple uses during a single burping session, with multiple panels and rigid durability while still allowing user comfort. The absorbent material system with a plurality of panels, processes of manufacture, and methods of use presented herein provides for collection of fluids through the absorption and/or adsorption processes as well as provides for other material properties such as durability, comfort, cleanliness and the like.

Additionally, the absorbent material system with a plurality of panels, processes of manufacture, and methods of use secures dispelled fluids therein. Additionally, the absorbent material system with a plurality of panels, processes of manufacture, and methods of use presented herein includes a plurality of panels to secure and/or remove dispelled liquids and/or other debris and/or other contaminants from a surface and/or other entity. The absorbent material system with a plurality of panels, processes of manufacture, and methods of use are easy to use and allow a user to confidently place the system and or use the system with ease.

Furthermore, the absorbent material system with a plurality of panels, processes of manufacture, and methods of use presented herein is environmentally friendly. The absorbent material system with a plurality of panels, processes of manufacture, and methods of use prevent a user from needing multiple burp cloths and/or washing multiple burp cloths and/or from disposing of multiple burp cloths. Additionally, the absorbent material system with a plurality of panels, processes of manufacture, and methods of use are safer for a user by preventing contamination of a user and infants.

The method of using the absorbent material system with a plurality of panels improves dramatically on the state of the art. While old burp cloths were difficult, cumbersome, wasteful, and messy, the current method of use and system is quick, efficient, fun, safe, easy, and reliable, clean, and environmentally friendly.

### BRIEF DESCRIPTION OF THE DRAWINGS

FIG. 1 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means;

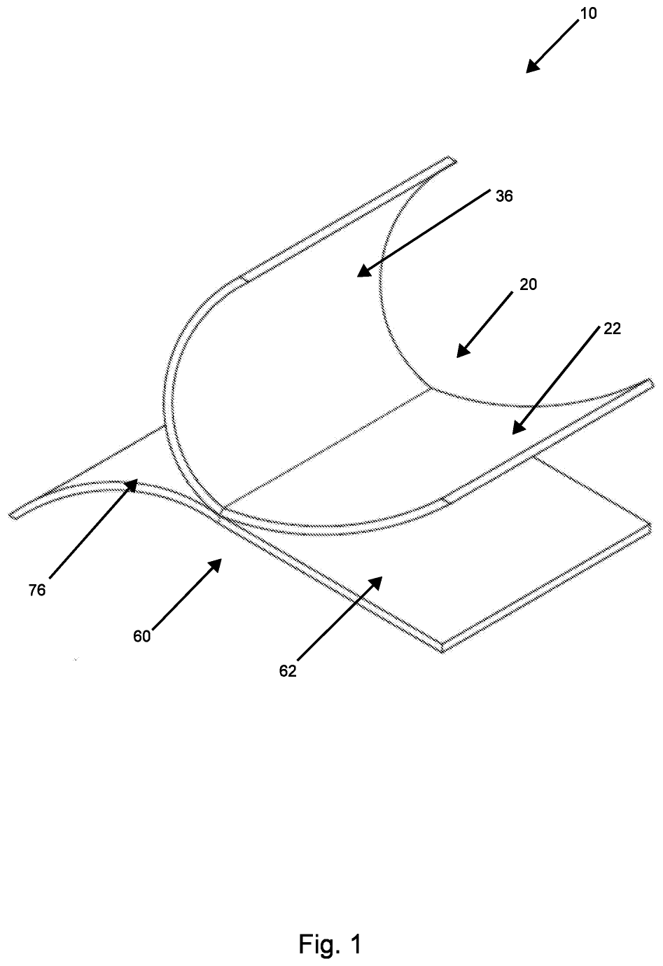

FIG. 2 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means;

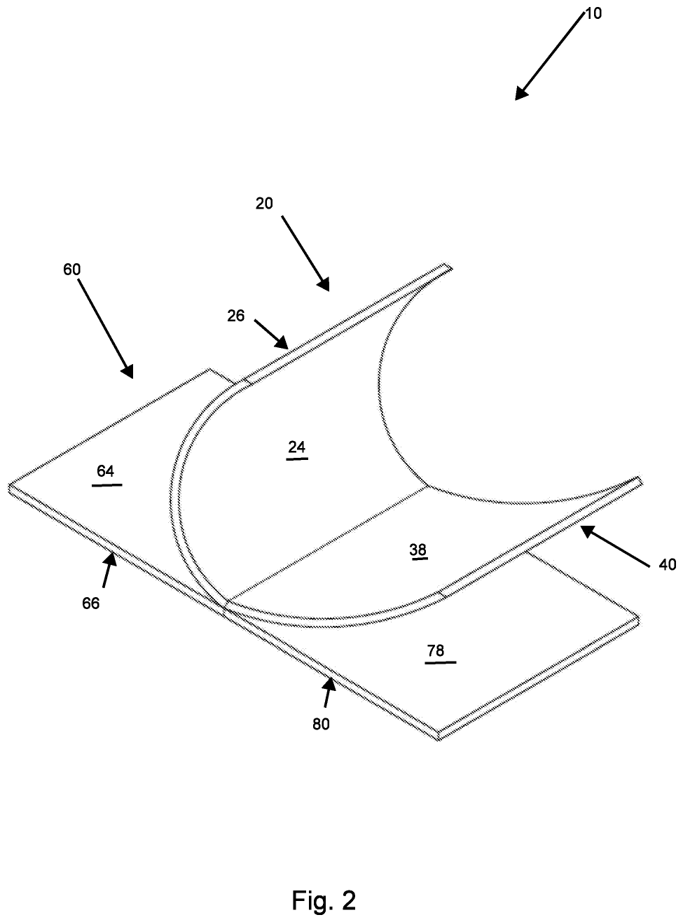

FIG. 3 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means;

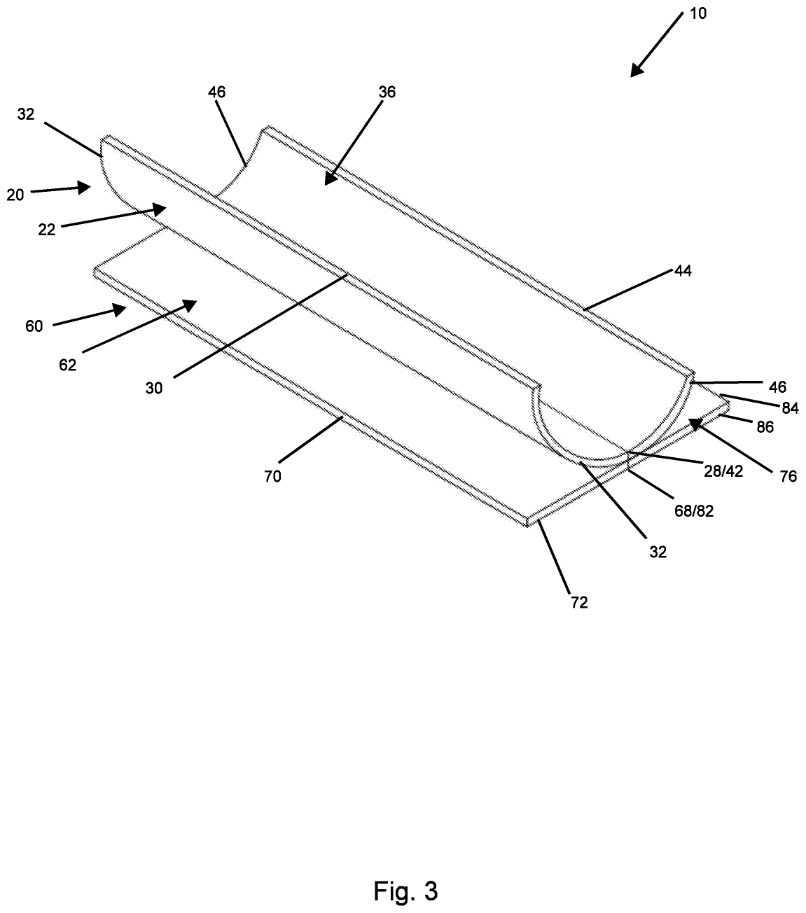

FIG. 4 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means;

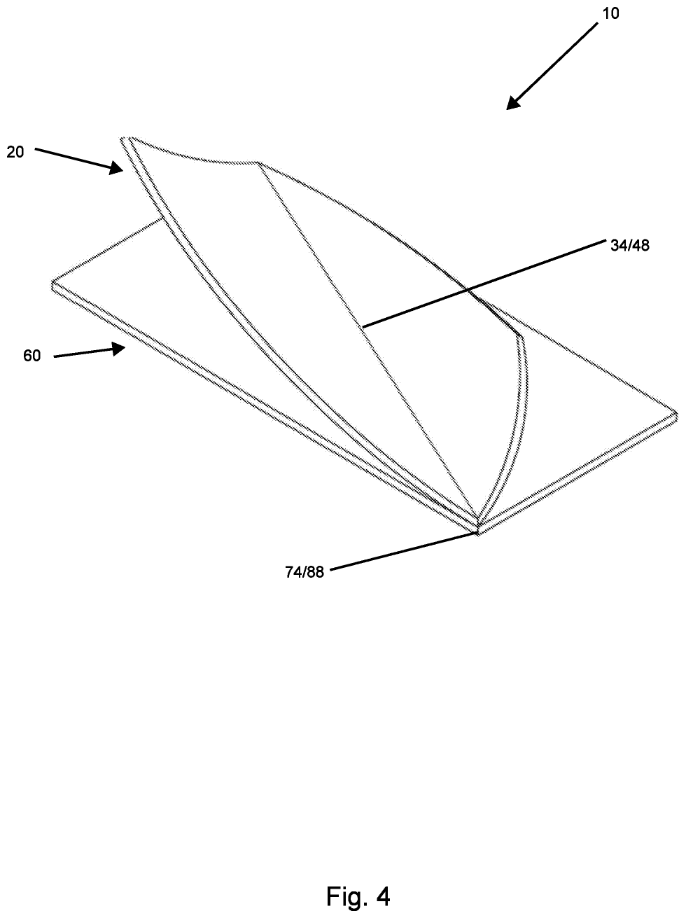

FIG. 5 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system having a third panel; the third panel of the absorbent material having a first portion; the third panel of the absorbent material having a second portion; the absorbent material system with a plurality of panels having an attachment means;

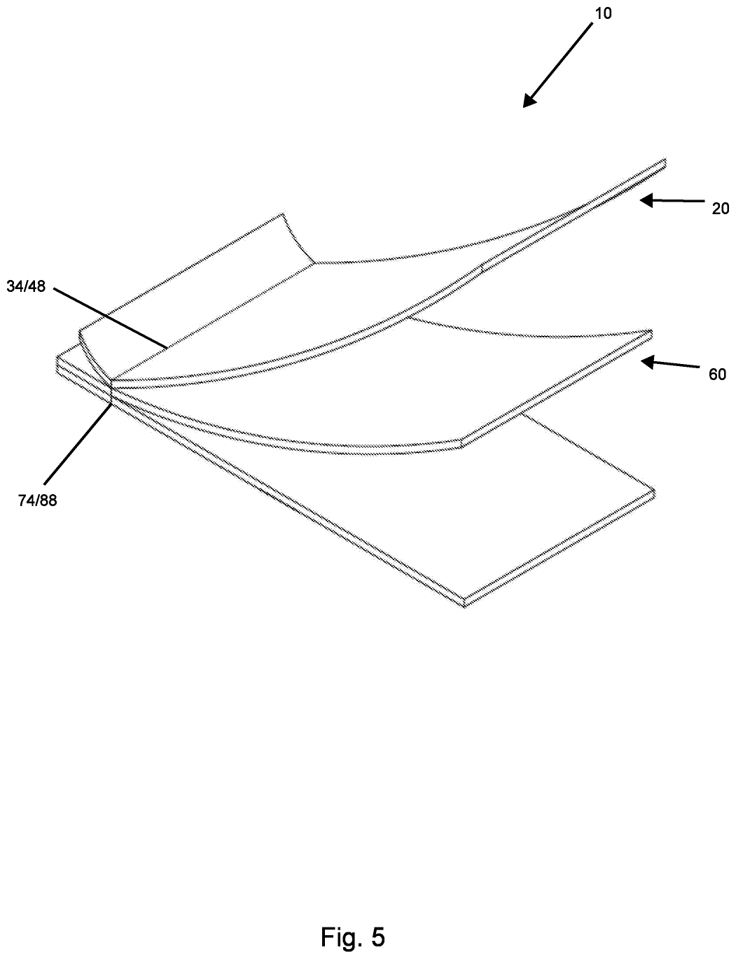

FIG. 6 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means; the absorbent material system having an attachment section;

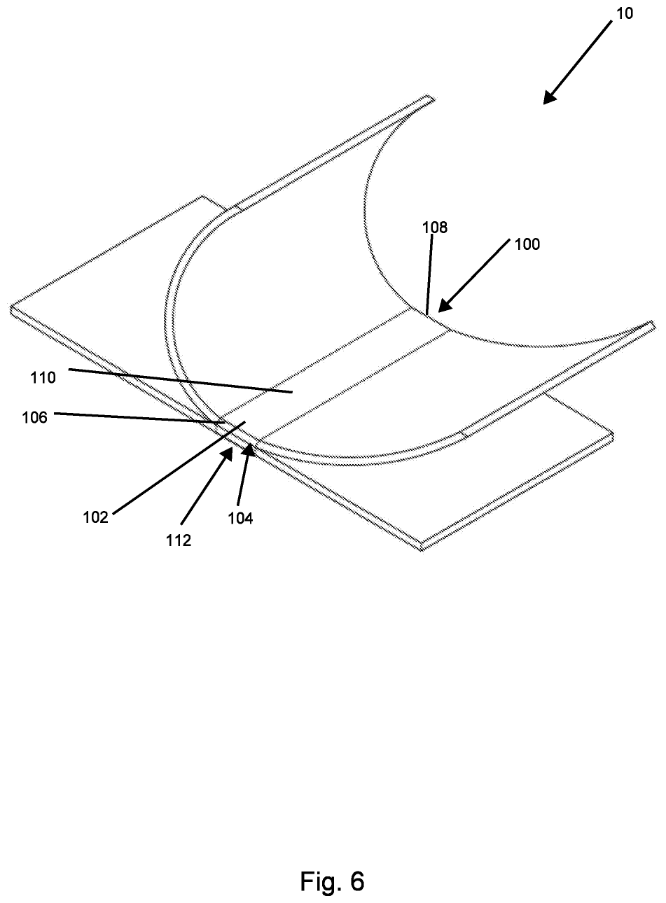

FIG. 7 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system having a third panel; the third panel of the absorbent material having a first portion; the third panel of the absorbent material having a second portion; the absorbent material system with a plurality of panels having an attachment means; the absorbent material system having an attachment section;

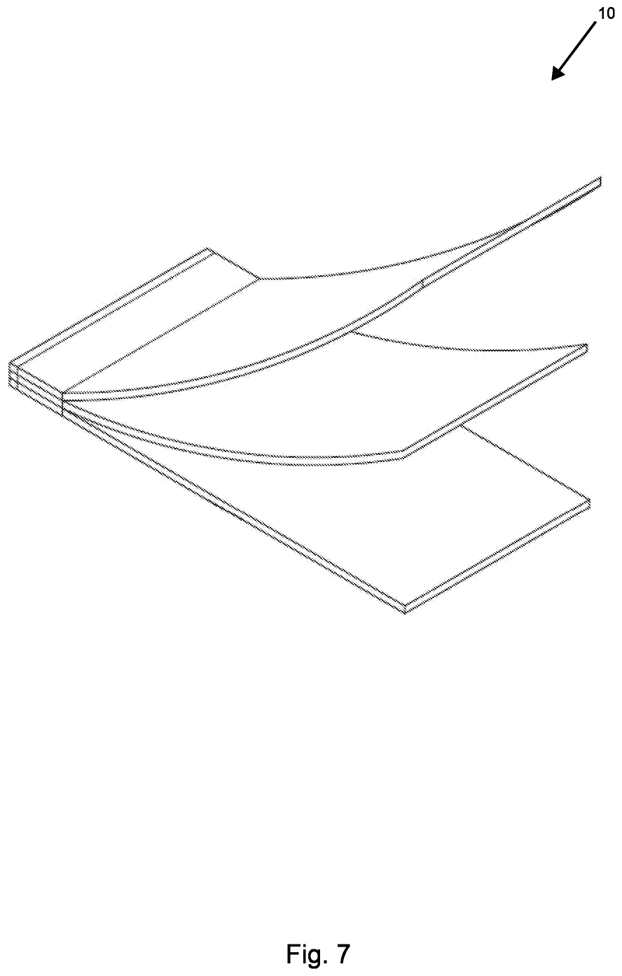

FIG. 8 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means;

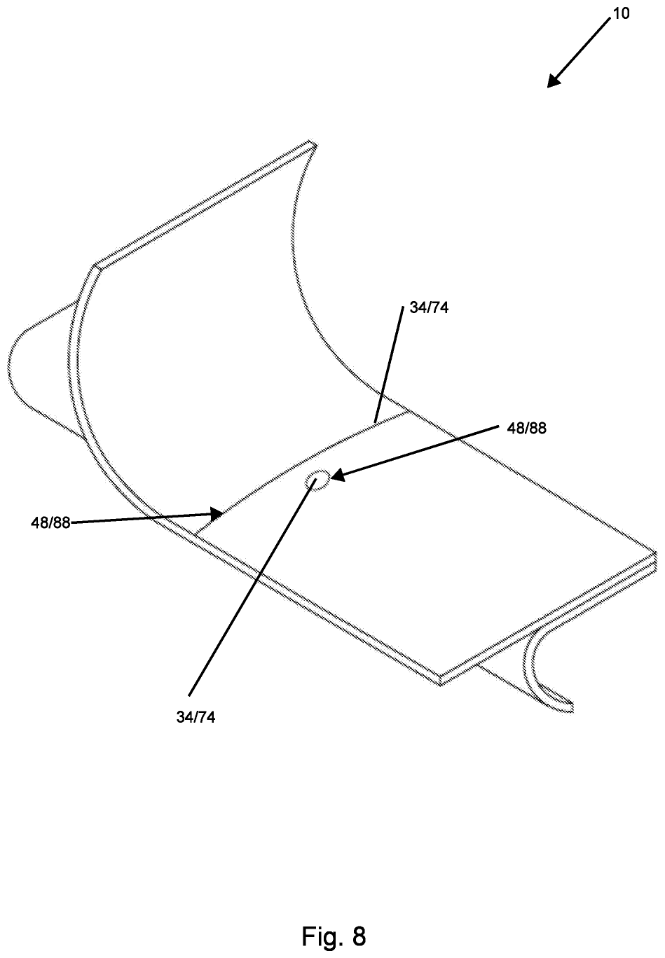

FIG. 9 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means;

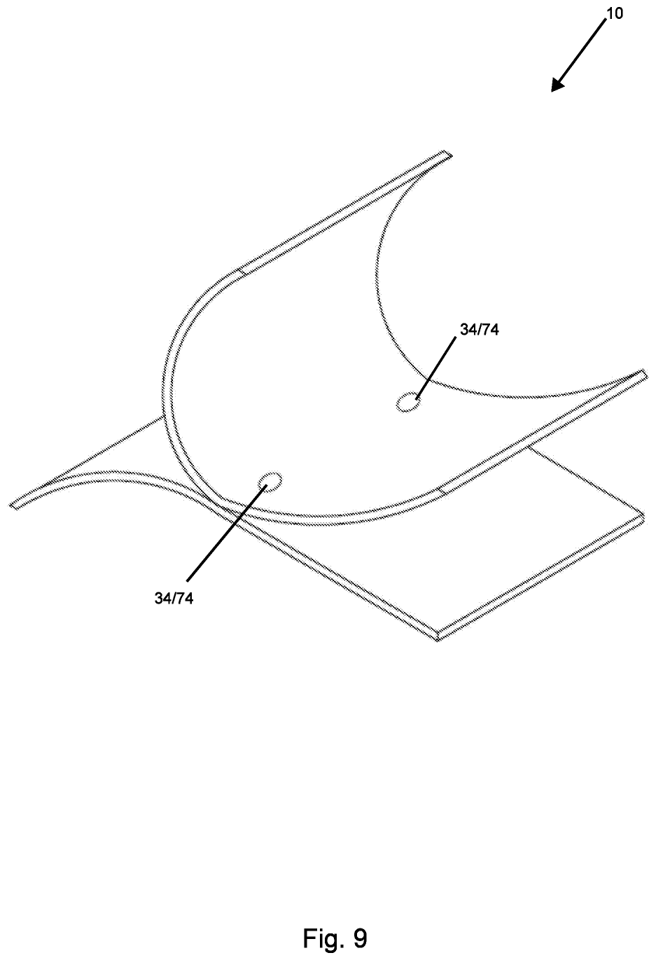

FIG. 10 is a top, perspective view showing the absorbent material system with a plurality of panels; the absorbent material system having a first panel; the absorbent material system having a second panel; the absorbent material system with a plurality of panels having an attachment means; the absorbent material system having an attachment section;

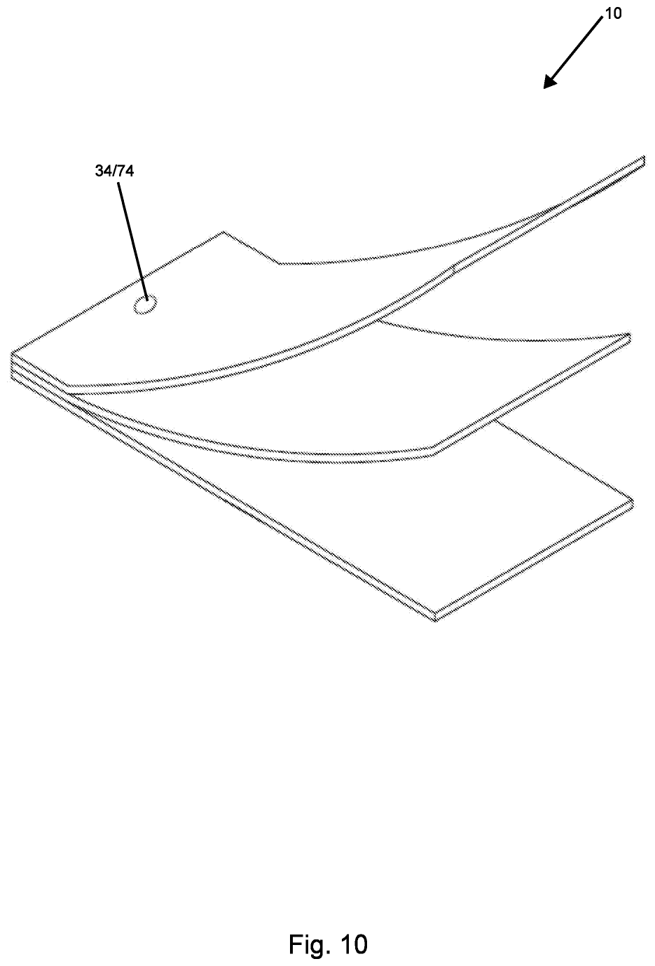

FIG. 11 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means; the absorbent material system having an attachment section; the view showing the absorbent material system having a pocket feature;

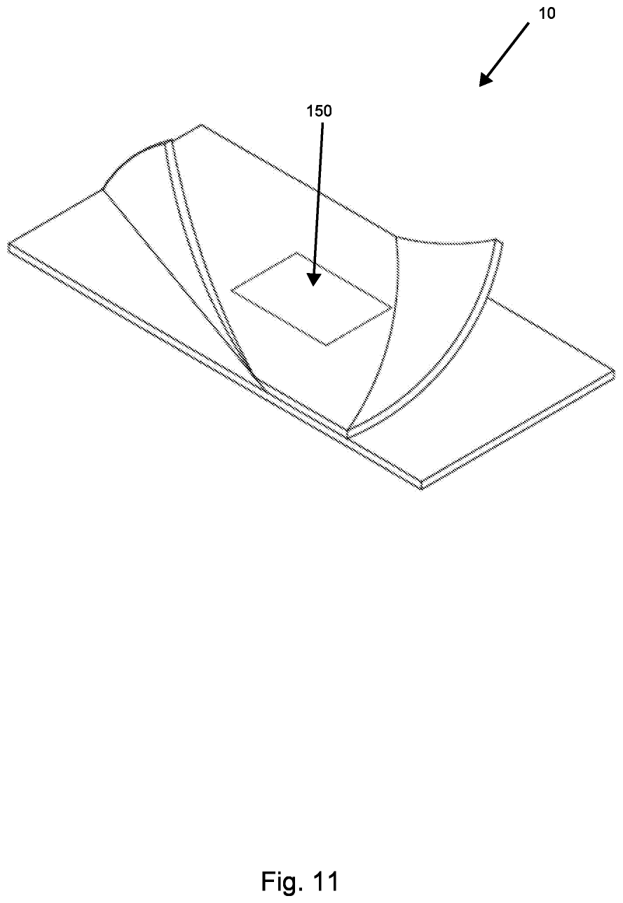

FIG. 12 is a top, perspective view showing the absorbent material system with a plurality of panels; the absorbent material system having a first panel; the first panel of the absorbent material system having a first portion; the first panel of the absorbent material system having a second portion; the absorbent material system having a second panel; the second panel of the absorbent material having a first portion; the second panel of the absorbent material having a second portion; the absorbent material system with a plurality of panels having an attachment means.

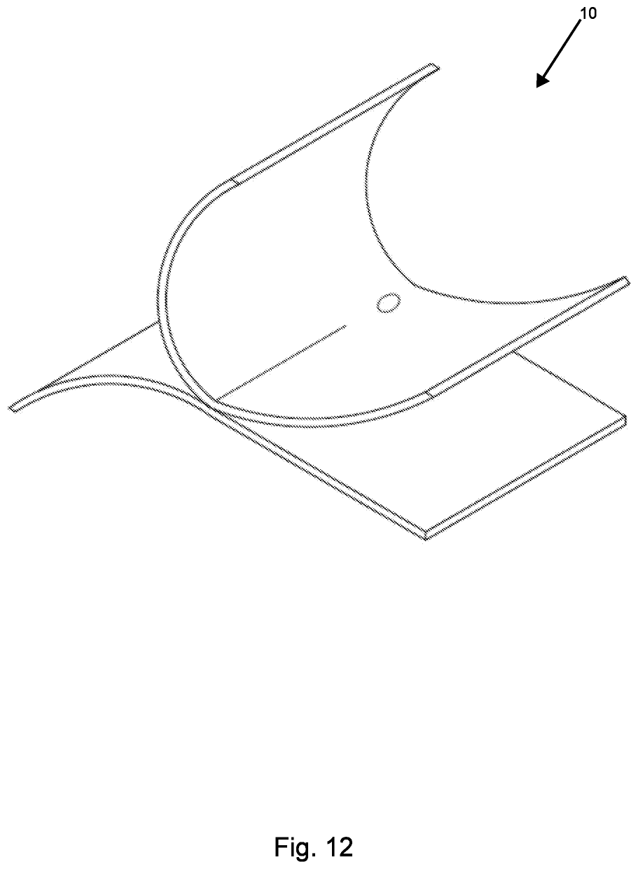

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

All illustrations of the drawings are for the purpose of describing selected versions of the present invention and are not intended to limit the scope of the present invention.

System:

With reference to the figures, an absorbent material system with a plurality of panels 10 is presented. Absorbent material system with a plurality of panels 10 (or “absorbent system”, or “absorbent material system”, or simply “system”) is formed of any suitable size, shape and design. In the arrangement shown, as one example, system 10 is configured to provide a burp cloth for multiple uses and having multiple panels arranged and attached such that a first panel can easily be moved or folded to expose a second panel to be used.

In the arrangement shown, as one example, absorbent material system 10 is formed of a first panel 20, a second panel 60, an attachment feature 100, and may also include an attached section 130, and a pocket feature 150, among other components and features.

First Panel:

In the arrangement shown, as one example, system 10 includes a first panel 20. First panel 20 (or “first panel”) is formed of any suitable size, shape, and design and is configured to collect, hold, and absorb dispelled fluids from a baby during the burping process. Alternatively, first panel 20 is configured to clean a mess of fluids and/or other messes and/or clean a surface of dust or other debris.

In the arrangement shown, as one example, the first panel 20 is formed primarily of a first body 22 operably connected to a second body 36 which are subsequently connected to a plurality of similar panels. In the arrangement shown, as one example, the first panel 20 is formed of a first body 22 and a second body 36. However, the first panel 20 may include any other number of bodies and may also include additional components, features, and the like. In another embodiment, and as is shown in one example, the first panel 20 also includes an attachment section 100 (attachment section 100 to be further discussed herein).

First Body:

In the arrangement shown, as one example, system 10 includes a first body 22. First body 22 (or “first portion”, or simply “panel”) is formed of any suitable size, shape and design and is configured as an absorbent panel which collects and absorbs dispelled fluids from a baby during the burping process. Alternatively, and in the example shown, the first body 22 is configured as an absorbent panel which can be used to wipe down and absorb the fluids or other debris from a mess and/or spill.

In the arrangement shown, as one example, the first body 22 is generally square in shape. In the arrangement shown, as one example, the first body 22 has a top surface 24, a bottom surface 26—being opposite the top surface 24. In the arrangement shown, as one example, the first body 22 extends from a first end 28 to a second end 30. In the arrangement shown, as one example, the first body 22 extends from the first end 28 to a second end 30 between a set of parallel opposing sides 32; the approximately parallel opposing sides 32 being in an approximately parallel spaced relation to one another.

In the arrangement shown, as one example, the first body 22 is generally square in shape when viewed from the top or the bottom. However, the first body 22 may be any shape as is adequate for a particular use. Other shapes for a first body 22 include, but are not limited to rectangular shapes, circular shapes, elliptical shapes, trapezoidal shapes, a combination thereof, and the like.

In the arrangement shown, as one example, the first body 22 is formed of a generally absorbent material such as a cloth, rag, or towel. However, first body 22 may be formed of any other material which is adequate for the particular task required, including but not limited to, an absorbent neutralizer material for handling hazardous and/or contaminated spills, an absorbent polymer for solidifying carbon or oil spills, a granular material made from recycled materials, a paper and/or a paper towel like material, a steel wool and/or metallic material and/or alloy, a high performance absorbent, a hydrophilic non woven fabric, a hydrophilic woven fabric, a modal fabric, a linen material, a cotton based material, a rayon based material, a microfibrous material, a hemp based fabric, a combination there, and the like.

In the arrangement shown, as one example, the first body 22 is formed of a single layer of absorbent material. However, the first body 22 may also include additional layers of materials as well as coatings and the like. For example, other layers include, but are not limited to a moisture barrier layer, a vinyl layer, a polyurethane laminate, an antibacterial layer, an antimicrobial layer, a disinfectant layer, a combination thereof, and the like.

Attachment Feature:

In the arrangement shown, as one example, the first body 22 is operably connected to system 10 by an attachment feature 34. Attachment feature 34 (or “attachment”, or “connection feature”, or “connecting feature”, or simply “connection”) is formed of any suitable size, shape, and design and is configured to attach the first body 22 to the rest of system 10.

In the arrangement shown, as one example, attachment feature 34 is formed of a stitched threading which extends the length of the first end 24 of the first body 22. In the arrangement shown, as one example, the stitched connection extends the entire length between the set of opposing sides 32. However, a partial stitch and other sizes, extensions, and formations of attachment feature 34 are hereby contemplated for use.

This connecting feature 34 is used to connect the first body to system 10 in a manner that allows first body 22 to be flipped, to be folded over, to be removed, to be tightened, to be loosened, and/or removed entirely such that subsequent panels can be utilized. Furthermore, in the arrangement shown, as one example, connecting feature 34 is an extended thread design so as to accommodate varying lengths, sizes, and shapes of panels.

In the arrangement shown, as one example, connecting feature 34 is formed of a course threading. However, any connecting feature is hereby contemplated for use, including but not limited to threads, snap-fit-features, frictional-fit-features, twist locking features, hook and loop, buttons, ties, zippers, peel and stick, an adhesive, a combination thereof, and the like.

Second Body:

In the arrangement shown, as one example, system 10 includes a second body 36. Second body 36 (or “second portion”, or simply “panel”) is formed of any suitable size, shape and design and is configured as an absorbent panel which collects and absorbs dispelled fluids from a baby during the burping process. Alternatively, and in the example shown, the second body 36 is configured as an absorbent panel which can be used to wipe down and absorb the fluids or other debris from a mess and/or spill.

In the arrangement shown, as one example, the second body 36 is generally square in shape. In the arrangement shown, as one example, the second body 36 has a top surface 38, a bottom surface 40—being opposite the top surface 38. In the arrangement shown, as one example, the second body 36 extends from a first end 42 to a second end 44. In the arrangement shown, as one example, the second body 36 extends from the first end 42 to a second end 44 between a set of parallel opposing sides 46; the approximately parallel opposing sides 46 being in an approximately parallel spaced relation to one another.

In the arrangement shown, as one example, the second body 36 is generally square in shape when viewed from the top or the bottom. However, the second body 36 may be any shape as is adequate for a particular use. Other shapes for a second body 36 include, but are not limited to rectangular shapes, circular shapes, elliptical shapes, trapezoidal shapes, a combination thereof, and the like.

In the arrangement shown, as one example, the second body 36 is formed of a generally absorbent material such as a cloth, rag, or towel. However, second body 36 may be formed of any other material which is adequate for the particular task required, including but not limited to, an absorbent neutralizer material for handling hazardous and/or contaminated spills, an absorbent polymer for solidifying carbon or oil spills, a granular material made from recycled materials, a paper and/or a paper towel like material, a steel wool and/or metallic material and/or alloy, a high performance absorbent, a hydrophilic non woven fabric, a hydrophilic woven fabric, a modal fabric, a linen material, a cotton based material, a rayon based material, a microfibrous material, a hemp based fabric, a combination there, and the like.

In the arrangement shown, as one example, the second body 36 is formed of a single layer of absorbent material. However, the second body 36 may also include additional layers of materials as well as coatings and the like. For example, other layers include, but are not limited to a moisture barrier layer, a vinyl layer, a polyurethane laminate, an antibacterial layer, an antimicrobial layer, a disinfectant layer, a combination thereof, and the like.

Attachment Feature:

In the arrangement shown, as one example, the second body 36 is operably connected to system 10 by an attachment feature 48. Attachment feature 48 (or “attachment”, or “connection feature”, or “connecting feature”, or simply “connection”) is formed of any suitable size, shape, and design and is configured to attach the second body 36 to the rest of system 10.

In the arrangement shown, as one example, attachment feature 48 is formed of a stitched threading which extends the length of the first end 42 of the second body 36. In the arrangement shown, as one example, the stitched connection extends the entire length between the set of opposing sides 46. However, a partial stitch and other sizes, extensions, and formations of attachment feature 48 are hereby contemplated for use.

This connecting feature 48 is used to connect the second body 36 to system 10 in a manner that allows second body 36 to be flipped, to be folded over, to be removed, to be tightened, to be loosened, and/or removed entirely such that subsequent panels can be utilized. Furthermore, in the arrangement shown, as one example, connecting feature 48 is an extended thread design so as to accommodate varying lengths, sizes, and shapes of panels.

In the arrangement shown, as one example, connecting feature 48 is formed of a course threading. However, any connecting feature is hereby contemplated for use, including but not limited to threads, snap-fit-features, frictional-fit-features, twist locking features, hook and loop, buttons, ties, zippers, peel and stick, an adhesive, a combination thereof, and the like.

In the arrangement shown, as one example, the first body 22 and the second body 36 share an attachment feature 34/48. Furthermore, in the arrangement shown, as one example, the first body 22 and the second body 36 may be formed of a single panel which is attached at a particular location. In this way, the first body 22 and the second body 36 are formed of a singular construction and utilize a singular attachment feature 34/48. However, other arrangements are hereby contemplated for use. For example, the first body 22 and the second body 36 may be two or more distinct constructions and may each utilize a separate attachment feature 34/48.

Second Panel:

In the arrangement shown, as one example, system 10 includes a second panel 60. second panel 60 (or “second panel”) is formed of any suitable size, shape, and design and is configured to collect, hold, and absorb dispelled fluids from a baby during the burping process. Alternatively, second panel 60 is configured to clean a mess of fluids and/or other messes and/or clean a surface of dust or other debris.

In the arrangement shown, as one example, the second panel 60 is formed primarily of a first body 62 operably connected to a second body 76 which are subsequently connected to a plurality of similar panels. In the arrangement shown, as one example, the second panel 60 is formed of a first body 62 of the second panel and a second body 76 of the second panel. However, the second panel 60 may include any other number of bodies and may also include additional components, features, and the like. In another embodiment, and as is shown in one example, the first panel 60 also includes an attachment section 100 (attachment section 100 to be further discussed herein).

First Body of Second Panel:

In the arrangement shown, as one example, second panel 60 includes a first body 62. First body 62 (or “first portion”, or simply “panel”) of the second panel 60 is formed of any suitable size, shape and design and is configured as an absorbent panel which collects and absorbs dispelled fluids from a baby during the burping process. Alternatively, and in the example shown, the first body 62 is configured as an absorbent panel which can be used to wipe down and absorb the fluids or other debris from a mess and/or spill.

In the arrangement shown, as one example, the first body 62 is generally square in shape. In the arrangement shown, as one example, the first body 62 has a top surface 64, a bottom surface 66—being opposite the top surface 64. In the arrangement shown, as one example, the first body 62 extends from a first end 68 to a second end 70. In the arrangement shown, as one example, the first body 62 extends from the first end 68 to a second end 70 between a set of parallel opposing sides 72; the approximately parallel opposing sides 72 being in an approximately parallel spaced relation to one another.

In the arrangement shown, as one example, the first body 62 is generally square in shape when viewed from the top or the bottom. However, the first body 62 may be any shape as is adequate for a particular use. Other shapes for a first body 62 include, but are not limited to rectangular shapes, circular shapes, elliptical shapes, trapezoidal shapes, a combination thereof, and the like.

In the arrangement shown, as one example, the first body 62 is formed of a generally absorbent material such as a cloth, rag, or towel. However, first body 62 may be formed of any other material which is adequate for the particular task required, including but not limited to, an absorbent neutralizer material for handling hazardous and/or contaminated spills, an absorbent polymer for solidifying carbon or oil spills, a granular material made from recycled materials, a paper and/or a paper towel like material, a steel wool and/or metallic material and/or alloy, a high performance absorbent, a hydrophilic non woven fabric, a hydrophilic woven fabric, a modal fabric, a linen material, a cotton based material, a rayon based material, a microfibrous material, a hemp based fabric, a combination there, and the like.

In the arrangement shown, as one example, the first body 62 is formed of a single panel of absorbent material. However, the first body 62 may also include additional layers of materials as well as coatings and the like. For example, other layers include, but are not limited to a moisture barrier layer, a vinyl layer, a polyurethane laminate, an antibacterial layer, an antimicrobial layer, a disinfectant layer, a combination thereof, and the like.

Attachment Feature:

In the arrangement shown, as one example, the first body 62 is operably connected to system 10 by an attachment feature 74. Attachment feature 74 (or “attachment”, or “connection feature”, or “connecting feature”, or simply “connection”) is formed of any suitable size, shape, and design and is configured to attach the first body 62 to the rest of system 10.

In the arrangement shown, as one example, attachment feature 74 is formed of a stitched threading which extends the length of the first end 64 of the first body 62. In the arrangement shown, as one example, the stitched connection extends the entire length between the set of opposing sides 72. However, a partial stitch and other sizes, extensions, and formations of attachment feature 74 are hereby contemplated for use.

This connecting feature 74 is used to connect the first body to system 10 in a manner that allows first body 62 to be flipped, to be folded over, to be removed, to be tightened, to be loosened, and/or removed entirely such that subsequent panels can be utilized. Furthermore, in the arrangement shown, as one example, connecting feature 74 is an extended thread design so as to accommodate varying lengths, sizes, and shapes of panels.

In the arrangement shown, as one example, connecting feature 74 is formed of a course threading. However, any connecting feature is hereby contemplated for use, including but not limited to threads, snap-fit-features, frictional-fit-features, twist locking features, hook and loop, buttons, ties, zippers, peel and stick, an adhesive, a combination thereof, and the like.

Second Body of Second Panel:

In the arrangement shown, as one example, system 10 includes a second body 76. Second body 76 (or “second portion”, or simply “panel”) is formed of any suitable size, shape and design and is configured as an absorbent panel which collects and absorbs dispelled fluids from a baby during the burping process. Alternatively, and in the example shown, the second body 76 is configured as an absorbent panel which can be used to wipe down and absorb the fluids or other debris from a mess and/or spill.

In the arrangement shown, as one example, the second body 76 is generally square in shape. In the arrangement shown, as one example, the second body 76 has a top surface 78, a bottom surface 80—being opposite the top surface 88. In the arrangement shown, as one example, the second body 76 extends from a first end 82 to a second end 84. In the arrangement shown, as one example, the second body 76 extends from the first end 82 to a second end 84 between a set of parallel opposing sides 86; the approximately parallel opposing sides 86 being in an approximately parallel spaced relation to one another.

In the arrangement shown, as one example, the second body 76 is generally square in shape when viewed from the top or the bottom. However, the second body 76 may be any shape as is adequate for a particular use. Other shapes for a second body 76 include, but are not limited to rectangular shapes, circular shapes, elliptical shapes, trapezoidal shapes, a combination thereof, and the like.

In the arrangement shown, as one example, the second body 76 is formed of a generally absorbent material such as a cloth, rag, or towel. However, second body 76 may be formed of any other material which is adequate for the particular task required, including but not limited to, an absorbent neutralizer material for handling hazardous and/or contaminated spills, an absorbent polymer for solidifying carbon or oil spills, a granular material made from recycled materials, a paper and/or a paper towel like material, a steel wool and/or metallic material and/or alloy, a high performance absorbent, a hydrophilic non woven fabric, a hydrophilic woven fabric, a modal fabric, a linen material, a cotton based material, a rayon based material, a microfibrous material, a hemp based fabric, a combination there, and the like.

In the arrangement shown, as one example, the second body 76 is formed of a single layer of absorbent material. However, the second body 76 may also include additional layers of materials as well as coatings and the like. For example, other layers include, but are not limited to a moisture barrier layer, a vinyl layer, a polyurethane laminate, an antibacterial layer, an antimicrobial layer, a disinfectant layer, a combination thereof, and the like.

Attachment Feature:

In the arrangement shown, as one example, the second body 76 is operably connected to system 10 by an attachment feature 48. Attachment feature 88 (or “attachment”, or “connection feature”, or “connecting feature”, or simply “connection”) is formed of any suitable size, shape, and design and is configured to attach the second body 76 to the rest of system 10.

In the arrangement shown, as one example, attachment feature 88 is formed of a stitched threading which extends the length of the first end 82 of the second body 76. In the arrangement shown, as one example, the stitched connection extends the entire length between the set of opposing sides 86. However, a partial stitch and other sizes, extensions, and formations of attachment feature 88 are hereby contemplated for use.

This connecting feature 88 is used to connect the second body 76 to system 10 in a manner that allows the second body 76 to be flipped, to be folded over, to be removed, to be tightened, to be loosened, and/or removed entirely such that subsequent panels can be utilized. Furthermore, in the arrangement shown, as one example, connecting feature 88 is an extended thread design so as to accommodate varying lengths, sizes, and shapes of panels.

In the arrangement shown, as one example, connecting feature 88 is formed of a course threading. However, any connecting feature is hereby contemplated for use, including but not limited to threads, snap-fit-features, frictional-fit-features, twist locking features, hook and loop, buttons, ties, zippers, peel and stick, an adhesive, a combination thereof, and the like.

In the arrangement shown, as one example, the first body 62 and the second body 76 share an attachment feature 74/88. Furthermore, in the arrangement shown, as one example, the first body 62 and the second body 76 may be formed of a single panel which is attached at a particular location. In this way, the first body 62 and the second body 36 are formed of a singular construction and utilize a singular attachment feature 74/88. However, other arrangements are hereby contemplated for use. For example, the first body 62 and the second body 76 may be two or more distinct constructions and may each utilize a separate attachment feature 74/88.

Attachment Section:

In one embodiment, and in the arrangement shown, as one example, system 10 includes an attachment section 100. Attachment section 100 (or “link section”, or simply “link”) is formed of any suitable size, shape, and design and is configured to secure the plurality of panels and the first body and second body of each of the plurality of panels to one another. In some embodiments this may be affixed in a permanent like arrangement. In yet other embodiments, as are shown, this may be a temporary place of securement until one or more panels are removed and/or detached.

Attachment section 100 may include an exterior surface 102, an interior surface 104, a first end 106, a second end 108, a top surface 110, and a bottom surface 112, among other components and features.

Pocket Feature:

In one embodiment, and in the arrangement shown, as one example, system 10 includes a pocket feature 150. Pocket feature 150 (or simply “pocket”) is formed of any suitable size, shape, and design and is configured to provide access in a variety of ways from one panel to another without removing panels and/or changing the position of the panels. Said another way, pocket feature 150 provides for a means of placing a hand, a waste, a fluid, or other control mechanisms in between the panels without removing and/or repositioning of the panel.

In one arrangement and as one use, a user may place their hand through the pocket feature to aid in wiping and/or cleaning of debris. In this way, the hand of the user won't become contaminated as it sits between the panels and or protected. Only the outer panel will be contaminated. In another arrangement, pocket feature 150 is configured to hold items such as a baby bottle, other wipes, toys, warmers, ice packs, medicine, and the like. In the arrangement shown, as one example, a single pocket feature 150 is shown, however, additional number of pocket features are also hereby considered including two pocket features, three pocket features, four pocket features, five pocket features, or more.

In the arrangement shown, as one example, pocket feature 150 includes a small opening between the first panel 20 and the second panel 60. Additionally, and in the arrangement shown, pocket feature 150 may also include an exterior surface, an interior surface, and an attachment feature, among other components and features.

### Alternative Embodiments

In alternative embodiments, and hereby considered for use, system 10 may also include other features, such as an alarm feature which sends a notification to a user's smart device when the system 10 has become soiled. Other features include a temperature sensor feature, a weight sensing feature to detect amounts of fluid, historical tracking of data, transceivers for sending information to a computer or personal computer device—such as a smartphone —, other resistors and detectors, warmers and timers, and the like.

Processes of Making/Manufacture:

In one example, and with reference to the figures, system 10 is presented. Additionally, a process of making system 10 is hereby contemplated for use. In one process of making and/or manufacturing, a plurality of panels is stitched together at a single location or along a set of vectors. Other attachment means are hereby contemplated for use.

In another process of making, a first and second body are attached to an attachment section which is then attached to a plurality of panels. In another variation on this process, a plurality of panels exist which include a first and second body with an attachment section connected thereto, the attachment sections are then attached to one another. These and other processes of making and/or manufacture are hereby contemplated for use along with the various methods of attachment considered herein or that are adequate for attaching a plurality of panels.

Methods of Use:

In many circumstances, a user and/or caretaker may desire to burp a baby multiple times during a feeding period. In this way, system 10 can be placed on the shoulder of the user. A baby can then be positioned such that if the baby dispels fluids, the fluids will land on the first panel of system 10. Once the first panel has been soiled, it is still desirable to rest the baby's head on the shoulder of a user and/or caretaker.

In order to avoid the baby resting its face in contaminants, a user merely needs to remove and/or reposition the first panel such that the second panel is exposed and the baby can rest it's head on the second panel upon the shoulder of a user. In this way, a plurality of panels are available to protect the clothing and or skin of the user from becoming contaminated. The above method of use may be repeated for one panel, two panels, three panels, or more, for as many panels are needed during the duration of a single feeding and/or burping session or for multiple feeding and/or burping sessions.

Alternative Method of Use:

In the event that a surface becomes dirty, such as a when a dog vomits on a floor or the like, a user may wish to use the first panel to first pick up the debris, and then fold the first panel and/or remove the first panel such that a second panel can be used to sterilize and/or clean the surface where the debris was removed. In this way, system 10 can be used to clean surfaces and/or remove messes in a variety of ways.

Alternative Method of Use:

In the event that a surface is not contaminated but perhaps only dusty or dirty, a user may desire to use the first panel as a duster and/or dust collector. A user can then use a second panel with a spray and or moisture to clean the surface after dust has been removed. A user may then reposition the first panel over the second panel to proceed dusting a second surface and then repeat the process over for as many times as needed such that the user has both a dry and a wet cleaner readily available.

These and other methods of use are hereby contemplated for use as have become apparent from the specification, the claims, and the drawings may imply. These methods of use include, but are not limited to, methods which include using a pocket feature for the baby's first instance of fluid dispel to hide the fluid away so that the baby's head can rest upon the first panel without the baby's face or other features becoming contaminated. Additionally, this includes using the pocket feature for holding ice packs, warming packs, medicine, and the like which aid in use.

It will be appreciated by those skilled in the art that other various modifications could be made to the device without parting from the spirit and scope of this disclosure. All such modifications and changes fall within the scope of the claims and are intended to be covered thereby.

What is claimed:

1. A material system, comprising:
a plurality of panels;
each of the plurality of panels having at least a first body;
the first body having a top surface;
the first body having a bottom surface;
the first body extending a length from a first end to a second end;
an attachment feature;
wherein the attachment feature operably connects a first panel to a second panel;
wherein the attachment feature operably connects the first panel to a second panel such that the first panel can be repositioned to expose the second panel;
the first panel having a material layer;
an attachment section.

2. The system of claim 1, further comprising:
each of the plurality of panels having at least a second body;
the second body having a top surface;
the second body having a bottom surface;
the second body extending a length from a first end to a second end.

3. The system of claim 1, further comprising:
wherein the plurality of panels are disposable.

4. The system of claim 1, further comprising:
a pocket feature.

5. The system of claim 1, further comprising:
wherein the attachment feature is a threaded connection.

6. The system of claim 1, further comprising:
wherein the attachment feature is a magnet.

7. The system of claim 1, further comprising:
wherein the attachment feature is a snap fit connection.

8. The system of claim 1, further comprising:
wherein at least one panel is insulated with a foam feature.

9. The system of claim 1, further comprising:
a pocket feature;
the pocket feature having an opening;
wherein the opening provides access from a top of a first panel to a top of a second panel.

10. The system of claim 1, further comprising:
the first panel further comprising a moisture barrier.

11. The system of claim 1, further comprising:
the second panel having an absorbent layer.

12. The system of claim 1, further comprising:
an antibacterial layer.

13. The system of claim 1, further comprising:
an antimicrobial layer.

14. The system of claim 1, further comprising:
wherein the first body of the first panel can be repositioned such that the bottom surface of the first panel can be used as an absorbing layer.

15. The system of claim 1, further comprising:
wherein the attachment feature is a button system.

16. The system of claim 1, further comprising:
wherein the attachment feature is a tear away system.

17. The system of claim 1, further comprising:
a weight sensor;
a fluid sensor;
a heat sensor;
a transceiver;
wherein the transceiver sends a signal to a computer.

18. A process of making an absorbent material system with a plurality of panels, the steps comprising:
providing a plurality of panels;
providing an attachment feature;
connecting a first panel to a second panel using the attachment feature;

19. A method of using an absorbent material system with a plurality of panels, the steps comprising:
providing a plurality of panels wherein each of the plurality of panels having a first body and each of the plurality of panels having a second body;
providing an attachment feature wherein the attachment feature operably connects a first panel to a second panel;
absorbing debris with one of the plurality of panels;
creating a contaminated panel by absorbing debris with one of the plurality of panels;
repositioning the plurality of panels such that a clean panel of the plurality of panels is exposed;
utilizing the clean panel of the plurality of panels.

20. The method of claim 19, further comprising the steps:
repositioning the plurality of panels such that a clean panel of the plurality of panels is exposed by removing completely and disposing of the contaminated panel.
